(19) United States
(12) Patent Application Publication
(10) Pub. No.: US 2023/0260148 A1
(43) Pub. Date: Aug. 17, 2023

(54) SYSTEM AND METHOD FOR GEOLOCATION OF AN OBJECT IN WATER

(71) Applicant: WITTED SRL, Rovereto (TN) (IT)

(72) Inventors: Andrea SAIANI, Trambileno (TN) (IT); Emanuele ROCCO, Trambileno (TN) (IT); Nadir PAGNO, Soranzen (BL) (IT); Isacco GOBBI, Casaleone (VR) (IT); Donato D'ACUNTO, Trento (IT)

(73) Assignee: WITTED SRL, Rovereto (TN) (IT)

(21) Appl. No.: 18/015,924

(22) PCT Filed: Jul. 13, 2021
(86) PCT No.: PCT/EP2021/069497

§ 371 Date: Jan. 12, 2023

(30) Foreign Application Priority Data
Jul. 14, 2020 (IT) 102020000017104

(51) Int. Cl. G06T 7/70; G06T 5/20; G06T 7/50; G06V 10/141; G06V 10/74; G06V 20/05

(52) U.S. Cl. CPC G06T 7/70; G06T 5/20; G06T 7/50; G06V 10/141; G06V 10/761; G06V 20/05

(57) ABSTRACT

A system for geolocation of an object in water includes:
first and second devices for immersion in, or to float on, water, the first device including a light source that emits a light beam; the second device includes a camera and a measuring device; and
a processing unit, operatively connected to the camera, and configured to:
   determine a vertical distance between the first and second devices based on the depth of both devices,
   capture a 2D image of the first device via the camera, calculate the pixel position in the image of the light beam from the light source,
   calculate a position of the first device relative to the main reference frame based on the pixel position of the light beam, the orientation of the camera, a position of the second device relative to the main reference frame and the vertical distance.

### TECHNICAL FIELD

The present invention relates to a system and a method for geolocation of an object in water.

### TECHNOLOGICAL BACKGROUND

The present invention is used particularly, though not exclusively, in the technical sector relating to the detection and the localization of an object, such as a drone, in an underwater environment.

Underwater localization has been extensively studied and many solutions are available today, mostly based on the acoustic communication channel and Underwater Wireless Sensors Network (UWSN). The main techniques are the following:
Ultra Short Baseline (USBL), where an underwater acoustic transponder acoustically responds to the acoustic signals of a transceiver mounted on the hull of a surface vessel. This has a transducer array to triangulate the underwater transponder by using signal run time and measuring the phase shift across the arrays. The USBL transducer array is made of an unique device.
Short Baseline (SBL): as the USBL, it requires a transducer array to triangulate an underwater transponder. Such array is connected with a central computing unit, but, in the SBL case, is made up instead of distinct wired modules, which could be so positioned on different sides of the surface vessel hull to achieve large transducer spacing. This increased baseline allows so for an improvement of positioning precisions of the underwater transponder.
Long Baseline System (LBL): Differently from the USBL and SBL, in LBL an underwater transponder determines its locations from an acoustic transponder buoy network, which are sea-floor mounted in known locations.

However, these techniques generally involve a complex network or transducer architecture, reason why the systems which implement such techniques are relatively expensive, difficult to be integrated with micro underwater robots or with portable device, might require complex calibration procedures and so expert personnel to handle them. Moreover, if they are acoustic based, they have maximum bandwidth limited by the speed of sound in water.

### STATEMENT OF INVENTION

The scope of this invention is to provide a system and a method for geolocation of an object in water which are structurally and functionally designed to overcome at least one of the drawbacks of the identified prior art.

This scope is achieved by of a system and a method for geolocation of an object in water obtained according to the respective independent claims appended to this description. The preferred characteristics of the invention are defined in the dependent claims. According to a first aspect of the invention, the system for geolocation of an object in water comprises a first device intended to be immersed in, or to float on, water. Preferably, the first device is an underwater drone, named also as remotely operated underwater vehicle (ROV).

Alternatively, the first device may be at least one of a boat, an apparatus fixed, or intended to be fixed, to the boat (in particular to the boat hull), a wearable device for a frogman, a floating device (e.g. a buoy) and a device anchored to a seabed.

The first device comprises a light source apt to emit a light beam.

Preferably, the light source is arranged at a top surface of first device.

The light source may be a LED device. Alternatively, the light source is a LASER device. Preferably, the light beam is a visible light, more preferably having wavelength of one of 450-485 nm, 500-565 nm. Alternatively, the light beam is a white light.

The system for geolocation further comprises a second device intended to be immersed in, or to float on, water.

Preferably, the second device is an underwater drone, named also as remotely operated underwater vehicle (ROV).

Alternatively, the second device may be at least one of a boat, an apparatus fixed, or intended to be fixed, to the boat (in particular to the boat hull), a wearable device for a frogman, a floating device (e.g. a buoy) and a device anchored to a seabed. The second device comprises a camera for taking 2D images and a measuring device arranged to provide an orientation of the camera relative to a main reference frame defined by three orthogonal axes X, Y, Z.

Preferably, the camera is arranged at a bottom surface of second device.

A 2D image is a two-dimensional image on the image plane of the camera.

Preferably, the main reference frame is a Cartesian coordinate system having the origin of the orthogonal axes X, Y, Z in a predetermined point of the Earth.

The main reference frame is used for specifying the position relative to the Earth of an object, wherein axes X and Y define an horizontal plane for the horizontal position of the object and the axis Z represents its vertical position, in particular the depth.

Axis Z extends along the gravity direction passing through a predetermined point, namely the vertical direction, and the horizontal plane is perpendicular to the vertical direction. The camera has a camera reference frame defined by three orthogonal axes X_{c}, Y_{c}, Z_{c}, wherein Z_{c} extends along the optical axis of the camera.

Preferably, the orientation of the camera relative to a main reference frame is defined by a set of three angles: pitch, roll and yaw, where pitch and roll are preferably given by a camera inertial measurement units comparing with the gravity vertical axis with the camera view direction, and yaw is preferably given by a camera magnetic sensor and considering pitch and roll with respect to the gravity vertical axis.

In other words, pitch is a rotation of the camera about the axis X_{c}, roll is a rotation of the camera about the axis Y_{c} and yaw is a rotation of the camera about the axis Z_{c}.

Preferably, the camera comprises inertial and magnetic sensors to measure the rotation of the camera about X_{c}, Y_{c}, Z_{c} axes to provide pitch, roll and yaw angles.

Alternatively the orientation of the camera is given by a set of orientation quaternions, q₁ q₂ q₃ q₄, given by the joint operation of the camera magnetic compass (and/or GPS compass) and inertial measurement unit.

The system for geolocation further comprises a processing unit operatively connected to at least the camera.

According to an embodiment of the invention, the processing unit may be a single computing apparatus or a computing system comprising several computing apparatuses. The several computing apparatuses are not necessarily connected to each other. One of several computing apparatuses is operatively connected to at least the camera.

Preferably, one of several computing apparatuses is comprised in the first device, second device or in a further device (in particular the further device is a remote device). Preferably, the second device comprises the processing unit or the processing unit is comprised in a further device (in particular the further device is a remote device) operatively connected to at least the second device, preferably to the first device and the second device.

The processing unit may comprise a microcontroller and/or a microprocessor. In addition or alternatively, the processing unit may comprise at least one of GPU (Graphics Processing Unit), ASIC (Application Specific Integrated Circuit), FPGA (Field Programmable Gate Array) and TPU (Tensor Processing Unit).

According to another aspect of the invention, the processing unit is configured to determine a vertical distance between the first device and the second device based on the depth in the water of both devices.

In particular, the depth in the water of the first device and the second device is the distance of the first device and the second device, respectively, from the surface of the water measured downward along a line parallel to the direction of the gravitational force. Alternatively, the depth in the water of the first device and the second device may be the distance of the first device and the second device, respectively, from a seafloor measured downward along a line parallel to the direction of the gravitational force. The vertical distance corresponds to distance along the vertical direction between the first device and the second device.

In particular, the vertical distance is the difference between the depth of the first device and the depth of second device.

Preferably, the depth of the first device is equal to zero if the first device floats on water. Preferably, the depth of the second device is equal to zero if the second device floats on water.

Preferably, the depth of the first device in the water is stored as data in a data storage or it is measured by a depth gauge comprised in the first device.

The depth gauge may comprise a pressure sensor measuring the vertical distance of the first device to the surface of the water, or an altitude sensor measuring the vertical distance of the first device to the seafloor.

Preferably, the processing unit is operatively connected to the data storage and\or to the depth gauge of the first device.

Preferably, the depth of the second device in the water is stored as data in a data storage or it is measured by a depth gauge comprised in the second device.

The depth gauge may comprise a pressure sensor measuring the vertical distance of the second device to the surface of the water, or an altitude sensor measuring the vertical distance of the second device to the seafloor.

These altitude sensors could be acoustic ones—such as echo sounders, multi-beam echo sounders, or other sonar solutions—or even optical ones—such as laser interferometers, lidar, or stereo/depth cams or even monocular cams using properly trained algorithms or imaging seafloor features of known proportions and sizes.

Preferably, the processing unit is operatively connected to the data storage and\or to the depth gauge of the second device.

Alternatively, the processing unit comprises the data storage.

According to an aspect of the invention, the processing unit is configured to capture a 2D image of the first device, in particular of the light beam emitted by the light source, through the camera.

For taking the 2D image of the first device, the first device and/or the second device (in particular the camera) are/is arranged so that the first device (in particular the light source) is inside the field of view of the camera.

According to an aspect of the invention, the processing unit is configured to calculate the pixel position p=(pᵤ,pᵥ) in the 2D image of light beam emitted by the light source of the first device.

The pixel position p of light beam, or more generally, of an object in the 2D image is the position expressed in pixel of that object relative to two orthogonal axes u,v extend along the two directions of the image plane of the camera and having origin preferably in a corner, more preferably in the left top corner, of the image plane.

Axes u,v define the image reference frame of the image plane.

In particular, the image reference frame is defined by two orthogonal axes u,v extend along the two directions of the image plane and having origin preferably in the top left corner of the image plane.

The calculation of the pixel position of light beam may be performed by any one of known object detection techniques of computer vision or other artificial intelligence techniques. Preferably, the calculation of the pixel position of light beam comprises a light beam detection.

Before describing an example of light beam detection, the following definitions are made:
Dilation: it is a morphological operator through which the output value assigned at the analyzed pixel is the maximum value taken from the set of pixels in the neighborhood. This morphological operator is applied to a binary image, so the pixel is 1 if any of the pixel in the neighborhood is 1. This operator makes blobs, which are uniform color spots of roundish shape, more visible and fills any eventual holes. Light beam gives origin to bright blobs in the camera image,
Erosion: it is a morphological operator opposite of Dilation, so the minimum value of the set of the neighborhood pixels is assigned to each output pixel. In a binary image the output pixel assumes a 0 value if any of the neighborhood pixels is 0. This operator makes blobs smaller and smoothed removing any eventually small isolated blobs,
Structuring element: it is a matrix which defines the dimension of the blobs and consequently of the neighborhood. This matrix is typically chosen of the same size and shape of the desired blobs. Preferably, the matrix shape is a circle or an ellipse.

According to an embodiment of the invention, the light beam detection comprises the following algorithm steps:
Converting the 2D image to grey-scale,
Applying a Gaussian blur, preferably with 5×5 kernel,
Converting the grey-scale image to binary image,
Making erosion and dilation through an elliptic structuring element with size controlled by the vertical distance between the first device and the second device,
Extraction of only blobs bigger than a specific size,
Contouring of the light zone,
Extracting the center of the zone and, preferably, drawing a circle there.

An example of size of the structuring element based on the vertical distance between the first device and the second device is summarized in the following table.

| Depth [m] | S.E. size - Erosion | S.E. size - Dilation |
|---|---|---|
| 2 | 20 × 20 | 15 × 15 |
| 3 | 12 × 12 | 12 × 12 |
| 4 | 4 × 4 | 8 × 8 |
| 5 | 1 × 1 | 10 × 10 |
| 6 | 1 × 1 | 12 × 12 |
| 7 | 1 × 1 | 12 × 12 |
| 8 | 1 × 1 | 15 × 15 |
| 9 | 1 × 1 | 15 × 15 |
| 10 | 1 × 1 | 15 × 15 |
| 11 | 1 × 1 | 18 × 18 |
| 12 | 1 × 1 | 20 × 20 |

Preferably, the light intensity of the light beam is controlled depending on the vertical distance between the first device and the second device. This allows to obtain a correct dimension of the light blob.

According to an aspect of the invention, the processing unit is configured to calculate a position of the first device relative to the main reference frame based on the pixel position of the light beam, the orientation of the camera, a position of the second device relative to the main reference frame and the vertical distance.

In particular, the position of the first device relative to the main reference frame is the position of the light beam emitted by the light source relative to the main reference frame.

Preferably, the position of the first device relative to the main reference frame is the position of the light source relative to the main reference frame.

According to an embodiment of the invention, the position of the second device relative to the main reference frame (X, Y, Z) is an information given by at least one of an absolute position sensor as GPS or similar, a real-time kinematic (RTK) positioning system as RTK-GPS, and a data storage.

In addition or alternatively to the above-mentioned localization techniques, the position of the second device relative to the main reference frame (X, Y, Z) is an information given by at least one of a mobile-phone tracking, a real-time locating system based on radio, optical or ultrasonic technology, and a positioning system based on methods of underwater acoustic positioning, as USBL, LBL or SBL.

These localization techniques can be used alone or in conjunction with other optical or acoustic methods or sensors measuring the displacement or velocity of the second device with respect to a seafloor, as optical or acoustic SLAM (Simultaneous Localization And Mapping) or DVL (Doppler Velocity Log) to increase the (geo) localization precision of the second device through one of known processes of data fusion.

Preferably, the second device comprises a GPS sensor, or more generally an absolute position sensor, for measuring the position of the second device relative to the main reference frame.

In particular, the position of the second device relative to the main reference frame is the position of the camera relative to the main reference frame.

Preferably, the calculation of the position of the first device relative to the main reference is based on a pinhole camera model, which is well known in the field of computer vision. In particular, in order to calculate the position of the first device relative to the main reference frame, an intrinsic camera matrix may be applied to the calculated pixel position p=(pᵤ,pᵥ) of the light beam, preferably followed by a distortion correction operation.

The intrinsic camera matrix is defined by camera parameters as:

$${C}_{m} = [ \begin{matrix}{f}_{x} & s & {c}_{x} \\ 0 & {f}_{y} & {c}_{y} \\ 0 & 0 & 1\end{matrix} ]$$

with fx and fy, the focal lengths expressed in pixel units.

It should be noted that fx, fy are the component x and y of the focal length (preferably expressed in pixel), where axes x,y are projections of axes Xc and Yc on the image plane and define a coordinate system of the image plane.

Moreover, cx and cy are the optical center coordinates in the coordinate system, both expressed in pixel, and s is the skew coefficient defined as s=fxtan(α). α is the angle between the camera x and y axes, so the skew coefficient (s) is non-zero when the image axes are not perpendicular.

According to an embodiment of the invention,

$${C}_{m} = [ \begin{matrix}387.84 & 0 & 329.86 \\ 0 & 386.03 & 179.79 \\ 0 & 0 & 1\end{matrix} ]$$

An adjusted position p′=(p′ᵤ,p′ᵥ) of the light beam is therefore obtained by following equation:

$$[ \begin{matrix}{p}^{′} \\ 1\end{matrix} ] := [ \begin{matrix}{p}_{u}^{′} \\ {p}_{v}^{′} \\ 1\end{matrix} ] = {Cm}^{- 1} \cdot [ \begin{matrix}{p}_{u} \\ {p}_{v} \\ 1\end{matrix} ]$$

The distortion correction operation may be applied to the adjusted position p′ to obtain an undistorted position pu=(puᵤ, puᵥ) of the light beam.

This operation is useful to correct possible distortions introduced by the camera hardware.

In geometric optics, such distortions comprise negative (or pincushion) distortion, positive (or barrel) distortion or tangential distortion. Negative and positive distortions, namely radial distortions, occurs when rays go more on the edges of the lens respect with the optical center of the camera whereas the tangential distortion occurs when the optical plane and the lens plane of the camera are not parallel.

In a particular embodiment of the invention, radial distortion can be corrected using the following model:

p′ᵤ=puᵤ(1+r²k₁+r⁴k₂+r⁶k₃)

p′ᵥ=puᵥ(1+r²k₁+r⁴k₂+r⁶k₃)

r²=puᵤ²+puᵥ²

where k₁, k₂, k₃ are the coefficients of lens radial distortion.

Regarding the tangential distortion, it can be corrected using the following model:

p′ᵤ=puᵤ[2p₁puᵤpuᵥ+p₂(r²+2puᵤ²)]

p′ᵥ=puᵥ[2p₂puᵤpuᵥ+P₁(r²+2puᵥ²)]

where p₁, p₂ are the coefficients of lens tangential distortion.

According to an embodiment of the invention,

$$[ \begin{matrix}{k}_{1} \\ {k}_{2} \\ {k}_{3} \\ {p}_{1} \\ {p}_{1}\end{matrix} ] = [ \begin{matrix}- 0.333 \\ 0.126 \\ - 0.0026 \\ - 0.0009 \\ - 0.018\end{matrix} ] .$$

According to an aspect of the invention, the coefficients of lens radial distortion and lens tangential distortion as well as the intrinsic camera matrix can be obtained by a geometric camera calibration process, which is known in the field of computer vision.

The undistorted position pu=(puᵤ, puᵥ) of the light beam is therefore obtained by solving the following equations:

puᵤ(1+r²k₁+r⁴k₂+r⁶k₃)+[2p₁puᵤpuᵥ+p₂(r²+2puᵤ²)]−p′ᵤ=0

puᵥ(1+r²k₁+r⁴k₂+r⁶k₃)+[2p₂puᵤpuᵥ+p₁(r²+2puᵤ²)]−p′ᵥ=0

and r=\sqrt{(puᵤ²+puᵥ²)}.

According to an embodiment of the invention, in order to calculate the position of the first device relative to the main reference frame, the unrotated vector p_{uR} can be obtained by following equation:

$${P}_{u R} := [ \begin{matrix}{P}_{u {R}_{X}} \\ {P}_{u {R}_{Y}} \\ {P}_{u {R}_{Z}}\end{matrix} ] = R [ \begin{matrix}p {u}_{u} \\ p {u}_{v} \\ 1\end{matrix} ]$$

where R is a rotation matrix which represents the orientation of the camera relative to a main reference frame. The rotation matrix R could be given from successive Euler rotations given the Euler angles (pitch, roll and yaw) measured by the inertial sensors, and preferably in their supposed order, or directly estimated from the inertial sensors supplied quaternions. In a particular embodiment, R can be given by the following matrix:

$$R = ( \begin{matrix}C [ ϕ ] C [ ψ ] & - C [ ψ ] S [ ϕ ] & S [ ψ ] \\ C [ θ ] S [ ϕ ] + C [ ϕ ] S [ θ ] S [ ψ ] & C [ θ ] C [ ϕ ] - S [ θ ] S [ ϕ ] S [ ψ ] & - C [ ψ ] S [ θ ] \\ S [ θ ] S [ ϕ ] - C [ θ ] C [ ϕ ] S [ ψ ] & C [ ϕ ] S [ θ ] + C [ θ ] S [ ϕ ] S [ ψ ] & C [ θ ] C [ ψ ]\end{matrix} )$$

where here C[ ] stands for the cos[ ] function, S[ ] for the sin[ ] function, ϕ=yaw, and ψ=roll and θ=pitch, whose rotations have been taken in this order.

Alternatively, R can be given by the following matrix:

$$R = ( \begin{matrix}1 - 2 {( {q}_{4} + {q}_{3} )}^{2} & 2 ( {q}_{2} {q}_{3} - {q}_{1} {q}_{4} ) & 2 ( {q}_{2} {q}_{4} + {q}_{l} {q}_{3} ) \\ 2 ( {q}_{2} {q}_{3} + {q}_{l} {q}_{4} ) & 1 - 2 {( {q}_{2} + {q}_{4} )}^{2} & 2 ( {q}_{3} {q}_{4} - {q}_{1} {q}_{2} ) \\ 2 ( {q}_{2} {q}_{4} - {q}_{1} {q}_{3} ) & 2 ( {q}_{3} {q}_{4} + {q}_{1} {q}_{2} ) & 1 - 2 {( {q}_{2} + {q}_{3} )}^{2}\end{matrix} )$$

where the q₁, q₂, q₃, q₄ are given by the joint operation of the camera magnetic compass (and/or GPS compass) and inertial measurement unit.

In a particular embodiment in which the camera is down looking and there no wave oscillations along X or Y axes (pitch=π and roll preferably the null constant),

$$R = ( \begin{matrix}Cos [ ϕ ] & - Sin [ ϕ ] & 0 \\ - Sin [ ϕ ] & - Cos [ ϕ ] & 0 \\ 0 & 0 & - 1\end{matrix} )$$

In an embodiment of the invention, p_{uR} can be renormalized, preferably in mm, to obtain P_{R}=(P_{R}_{ₓ}, P_{R}_{_{y}}, P_{R}_{_{z}}) according to the equation:

P_{R}=P_{uR}α

In an embodiment of the invention α=Z_{L}, where Z_{L} is the (minimum) distance between the camera plane and the light plane. Preferably, the light plane is the plane parallel to the camera plane and passing through the point in space defined by the light source. In an embodiment of the invention, Z_{L} can be given by the

Z_{L}=Δz Sec(ψ−ArcTan(puᵤ))Sec(θ−ArcTan(−puᵥ))/(\sqrt{1+puᵤ²}\sqrt{1+puᵥ²})

With Sec the secant function, ψ=roll and θ=pitch, and Δz the vertical distance between the first device and the second device based on the depth in the water of both devices. Δz is preferably given by the difference between the depth of the first device and the depth of second device (in particular the depth of the light source and the depth of the camera), with both depths preferably being negative values if both devices are submerged.

Preferably, the vertical distance Z_{L} is in millimetres and, consequently, the position PR of the light beam is in millimetres.

Alternatively, α can be obtained by solving the following equation in a:

p_{uR}_{_{z}}α=Δz

Where Δz is still the vertical distance between the first device and the second device based on the depth in the water of both devices. Δz is preferably given by the difference between the depth of the first device and the depth of second device (in particular the depth of the light source and the depth of the camera), with both depths preferably being negative values if both devices submerged.

In a particular embodiment in which the camera is down looking and there no wave oscillations along X or Y axes, i.e. pitch=π and roll preferably the null constant:

Z_{L}=−Δz

According to an aspect of the invention, the position P=(P_{X},P_{Y},P_{Z}) of the first device relative to the main reference frame (X,Y,Z) can therefore be obtained by the translation equation:

P=P_{R}+t

where t=(t_{X}, t_{Y}, t_{Z}) is a translation vector which represents the position of the second device (in particular of the camera) relative to the main reference frame (X,Y,Z). The translation vector t could be given by an absolute position sensor or a real-time kinematic (RTK) positioning system, or it could be obtained from a data storage. Pz preferably can be substituted with the depth of the first device (in particular the light source), since it can be directly measured with very small error.

Since the vertical distance Δz between the first device and the second device, and the distance between the camera and the light plane Z_{L} are preferably in millimetres, the position P of the first device is in millimetres too.

In alternative or in addition, the processing unit is configured to calculate a position of the second device relative to the main reference frame based on the pixel position of the light beam, the orientation of the camera, a position of the first device relative to the main reference frame and the vertical distance.

In this case, the position of the first device relative to the main reference frame (X, Y, Z) is an information given by at least one of an absolute position sensor as GPS or similar, a real-time kinematic (RTK) positioning system as RTK-GPS and a data storage.

In addition or alternatively to the above-mentioned localization techniques, the position of the first device relative to the main reference frame (X, Y, Z) is an information given by at least one of a mobile-phone tracking, a real-time locating system based on radio, optical or ultrasonic technology, and a positioning system based on methods of underwater acoustic positioning, as USBL, LBL or SBL.

These localization techniques can be used alone or in conjunction with other optical or acoustic methods or sensors measuring the displacement or velocity of the first device with respect to a seafloor, as optical or acoustic SLAM (Simultaneous Localization And Mapping) or DVL (Doppler Velocity Log) to increase the (geo) localization precision of the first device through one of known processes of data fusion.

Preferably, the first device comprises a GPS sensor, or more generally an absolute position sensor, for measuring the position of the first device relative to the main reference frame.

The position of the second device relative to the main reference frame (X, Y, Z) may be calculate by the above-mentioned procedure in which the translation vector t=(t_{X}, t_{Y}, t_{Z}) now represents the position of the first device relative to the main reference frame (X,Y,Z).

These features allow to calculate the position of the first device and/or second device by using a camera and a light beam instead of known localization techniques, thus getting a simple system, in terms of architectural complexity, for geolocation of an object in water. Contrary to acoustic devices, being light based, the system has the propagation delay between target and the detector which is negligible when compared to computing times. The detection speed of the light position changes is very fast and limited only by the FPS (Frame per Second) of the camera, and the speed of the computing units.

The system could have bandwidth easily surpassing hundreds Hz, while high-end versions with high speed camera and computing units could surpass the kHz. Fast acquisition rate allows also for a reduction of the statistical positioning error enhancing the effectiveness of downstream filters o state estimations algorithms.

The positioning errors also are limited only by the camera resolution, sensitivity, light beam shape and water conditions. In the camera reference frame, until the light source is detectable by the camera, it is possible to easily reach uncertainties at the level of cm and below. Moreover, in the shallow water or near the seafloor or surface, the position measurement is not affected and limited by signal reflections as in acoustic positioning. If the line of sight is established, it could well operate in caves. Contrary to UWSN, the system allows the localization of the light source with one camera only. The simplicity of the systems allows so its miniaturization and deployment on micro underwater robots, or on frogmen portable devices. It allows also for very much reduced costs of localization and wide adoption by professional and non professional users as well.

According to an embodiment of the invention, the position of the second device or the first device used for calculating the position of the first device or the second device, respectively, is stored in a data storage or provided by a position device.

According to an embodiment of the invention, the depth of the first device and/or the second device in the water is stored in a data storage or measured by a depth gauge. Therefore, the position of the second device or the first device used for calculating the position of the first device or the second device, respectively, is stored in a data storage or provided by a position device and/or the depth of the first device and/or the second device in the water is stored in a data storage or measured by a depth gauge.

As mentioned before, the depth gauge may comprise a pressure sensor measuring the vertical distance of the first device to the surface of the water, or an altitude sensor measuring the vertical distance of the first device to the seafloor.

In other words, the position of the second device or the first device used for calculating the position of the first device or the second device, respectively, is stored in a data storage or provided by a position device and the depth of the first device in the water is stored in the data storage or measured by a depth gauge comprised in the first device and the depth of the second device in the water is stored in the data storage or measured by a depth gauge comprised in the second device.

The data storage may consist of a single storage medium or several storage mediums. The single storage medium may be comprised in the first device, in the second device or in a further device (e.g. a, apparatus located on the ground).

The several storage mediums may be included in a single device (e.g. the first device, the second device or a further device which can be located, for example, on the ground) or in respective different devices.

For instance, the depth of the first device can be stored in a storage medium of the first device and/or in a storage medium of the second device and/or in a storage medium of a further device.

For instance, the depth of the second device can be stored in a storage medium of the first device and/or in a storage medium of the second device and/or in a storage medium of a further device.

For instance, if the position of the first device relative to the main reference frame is to be calculated, the position of the second device relative to the main reference frame can be stored in a storage medium of the first device and/or in a storage medium of the second device and/or in a storage medium of a further device.

For instance, if the position of the second device relative to the main reference frame is to be calculated, the position of the first device relative to the main reference frame can be stored in a storage medium of the first device and/or in a storage medium of the second device and/or in a storage medium of a further device.

The storage medium can be also a cloud storage if one device is connected to it, and information retrieved at need.

Preferably, the processing unit is operatively connected to the data storage and/or the position device so as to obtain the position of the second device or the first device for calculating the position of the first device or the second device, respectively, and the processing unit is operatively connected to the data storage and/or the depth gauge of the first device so as to obtain the depth of the first device in the water and to the data storage and/or the depth gauge of the second device so as to obtain the depth of the second device in the water for determining the vertical distance.

Preferably, the position device comprises an absolute position sensor as GPS or similar. According to an embodiment of the invention, the position device comprises at least one of an absolute position sensor, a real-time kinematic (RTK) positioning system, a mobile-phone tracking, a real-time locating system based on radio, optical or ultrasonic technology, and a positioning system based on methods of underwater acoustic positioning, as USBL, LBL or SBL.

Preferably, the position device comprises a GPS sensor, in particular a GPS receiver, which is an absolute position sensor or a position sensor of the RTK positioning system.

Preferably, the first device or the second device is provided with the position device. According to an embodiment of the invention, the measuring device of the second device comprises inertial sensors and/or a magnetometer and/or GPS compass for providing the orientation of the camera relative to the main reference frame.

According to an embodiment of the invention, the first device comprises a first control unit connected to the light source for the modulation of light beam so that the light beam transmits information about the position and/or depth of the first device. The modulation may be a light intensity modulation, which could be done by on-off keying, frequency-shift keying, or quadrature amplitude modulation, among other methods

The second device comprises an optical sensor apt to detect the light beam, the processing unit being connected to the optical sensor for obtaining the position and/or depth of the first device based on the light beam detected by the optical sensor. In particular, the optical sensor is a photodiode or a photomultiplier or other photon detector, preferably arranged next to the camera. Alternatively, the camera comprises the optical sensor.

This feature allows to transmit information about the position and/or depth of the first device by using light beam, thus avoiding using additional technical means for this aim. According to an embodiment of the invention, one of the first device and the second device has an acoustic emitter for emitting an acoustic signal which represents the position and/or depth of the relevant device and the other of the first device and the second device has an acoustic receiver for receiving the acoustic signal emitted by the acoustic emitter.

The processing unit is connected to the acoustic receiver for obtaining the position and/or depth of the one of the first device and the second device based on the signal received by the acoustic receiver.

With respect to the light modulation communication, the acoustic link could allow for continuous communication of the light motion and depth state to the camera even in the case of temporary interruption of line of sight. This information could be used by the camera computing units and algorithms to estimate the light location even during the small time intervals when the light source could not detected due to various reasons. According to an embodiment of the invention, the first device and the second device are connected to each other by a marine communication cable through which the first device transmits to the second device information on its depth and/or position and/or the second device transmits to the first device information on its depth and/or position.

The marine cable is particular advantageous for tethered ROVs which could use their own cable for the communication link between light source and camera. It allows so a retrofit of the light localization system on underwater tethered vehicles which are already in deployment.

Preferably, the marine communication cable is a tether cable.

Preferably, the marine communication cable is an electrical cable or fibre optic cable. According to an embodiment of the invention, at least one of the first device and the second device has an acoustic emitter for emitting an acoustic signal which represents the position and/or depth of the relevant device and/or has a marine communication cable through which it transmits to another device information on its depth and/or position.

For example, the another device may be a device arranged on land, boat or buoy. Preferably, the another device is configured to relay the received information position and/or depth of the relevant device to the other of the first device and the second device. According to an embodiment of the invention, the processing unit is configured to predict a next position of the light beam in the 2D image captured through the camera by performing a recursive filtering algorithm based on at least an actual position and previous positions of the light beam in the 2D image.

This feature allows to perform a trajectory estimation of the light beam over time. Preferably, the recursive filtering algorithm is a Kalman filter.

The prevision of Kalman filter allows to carry out the light beam tracking so as to avoid or limit detection errors of the light beam, for instance caused by at least one of occlusion, illumination change and rapid motions of the light beam.

It will be described below the Kalman filter according to an embodiment of the invention. The Kalman filter system used to predict the next position, or state, of the light beam in the 2D image, assumes that the light position and velocity evolve according the following:

sₖ=Tsₖ₋₁+wₖ₋₁

where:

k is the time-step,

sₖ,sₖ₋₁ are actual ad previous states,

T is the Transition matrix,

wₖ₋₁ is the Process noise vector (preferably this process noise is a zero-mean Gaussian).

It is assumed that there is no control input.

Kalman filter has an Observation vector oₖ which is linked to sₖ with the following:

oₖ=Hsₖ+vₖ

where:

H is the Observation matrix,

vₖ is the Observation noise vector (preferably this observation noise is a zero-mean Gaussian).

The state and the observation vectors are defined by:

$${s}_{k} = [ \begin{matrix}{χ}_{k} \\ {y}_{k} \\ {\dot{x}}_{k} \\ {\dot{y}}_{k}\end{matrix} ]$$

$${o}_{k} = [ \begin{matrix}{x}_{{o}_{k}} \\ {y}_{{o}_{k}}\end{matrix} ]$$

According to an embodiment of the invention, given the simple physical model of the light position dynamic, T is independent from k and it is given by the:

$$T = [ \begin{matrix}1 & 0 & Δ k & 0 \\ 0 & 1 & 0 & Δ k \\ 0 & 0 & 1 & 0 \\ 0 & 0 & 0 & 1\end{matrix} ]$$

with Δₖ being the time delay between the state sₖ and sₖ₋₁.

Since the observed variables are just the first two terms of the state vector, H is simply the following:

$$H = [ \begin{matrix}1 & 0 & 0 & 0 \\ 0 & 1 & 0 & 0\end{matrix} ]$$

In an embodiment of the invention, at the k time-step, the Kalman filter consists of two steps: predict and update. The first step is the estimation of the s′ₖ state and the Covariance matrix P′ₖ, which are calculated by following:

s′ₖ=Tsₖ₋₁

P′k=TPₖ₋₁T^{T}+Q

Q is the estimate of the process noise covariance of wₖ.

For k null u₀ is a null vector, s₀ and P₀ assumed to be:

$${s}_{0} = [ \begin{matrix}{x}_{0} \\ {y}_{0} \\ {\dot{x}}_{0} \\ {\dot{y}}_{0}\end{matrix} ]$$

$${P}_{0} = [ \begin{matrix}{σ}_{x} & 0 & 0 & 0 \\ 0 & {σ}_{y} & 0 & 0 \\ 0 & 0 & {σ}_{\dot{x}} & 0 \\ 0 & 0 & 0 & {σ}_{\dot{y}}\end{matrix} ]$$

where σₓ, σ_{y}, σ_{\dot{x}} and σ_{\dot{y}} are the uncertainties of each component and assuming no correlation between the components. The correction stage of Kalman filter calculates the Kalman gain, Kₖ, the state sₖ and the Covariance matrix Pₖ with the:

Kₖ=P′ₖH^{T}(HP′ₖH^{T}+J)⁻¹

Sₖ=S′ₖ+Kₖ(oₖ−Hs′ₖ)

Pₖ=(I−KₖH)P′ₖ

Pₖ represents reliability of the measurement. In this embodiment, J is a null matrix.

xₒ_{ₖ} and yₒ_{ₖ} are respectively puᵤ and puᵥ of the undistorted pixel position of the light beam.

According to an embodiment of the invention, the first device and/or the second device has both the light source and the camera preferably arranged on an opposite side to the light source.

According to an embodiment of the invention, the system comprises a third device intended to be immersed in, or to float on, water and at least one of the first device, second device and third device has both the light source and the camera.

In this way, the position of the first device relative to the main reference can be calculated by means of the camera of the third device and the position of third device relative to the main reference can be calculated by means of the camera of the second device.

This feature allows to immerge the first device in the water at greater depths.

According to an aspect of the invention, the method for geolocation of an object in water, comprises the following steps:
putting a first device into water, wherein the first device comprising a light source apt to emit a light beam,
putting a second device into the water, the second device comprising a camera for taking images,
emitting the light beam by means of the light source,
obtaining an orientation of the camera relative to a main reference frame defined by three orthogonal axes (X, Y, Z),
obtaining the depth of the first device and the second device in the water,
determining a vertical distance between the first device and the second device based on the depth thereof in the water,
capturing a 2D image of the first device through the camera,
calculating the pixel position in the 2D image of light beam emitted by the light source of the first device, and
obtaining a position of the second device relative to the main reference frame and calculating a position of the first device relative to the main reference frame based on the pixel position of the light beam, the orientation of the camera, the position of the second device relative to the main reference frame and the vertical distance, or obtaining a position of the first device relative to the main reference frame and calculating a position of the second device relative to the main reference frame based on the pixel position of the light beam, the orientation of the camera, the position of the first device relative to the main reference frame and the vertical distance.

It should be noted that the method according to the invention can be carried out in real-time, i.e. the position of the first device or the second device relative to the main reference frame is calculated upon the depth of the first device and/or the depth of the second device and/or the position of the second device or the first device relative to the main reference frame is/are measured.

In addition or alternatively, the method according to the invention can be carried out off-line, in particular after the data acquisition through a post processing activity, i.e. at least the depth of the first device and the second device (and/or the vertical distance) and the position of the second device or the first device relative to the main reference frame are stored in a data storage, in particular the depth and position are first measured and then stored in the data storage, and the position of the first device or the second device relative to the main reference frame is calculated with a delay in relation to the production of that data.

In this case, the processing unit may be, for example, a computing system comprising several computing apparatuses, wherein a first computing apparatus is operatively connected to at least the camera and configured to:
determine a vertical distance between the first device and the second device based on the depth in the water of both devices,
capture a 2D image of the first device through the camera,
calculate the pixel position in the 2D image of light beam emitted by the light source of the first device,

and a second computing apparatus is configured to calculate off-line the position of the first device and/or the second device relative to the main reference frame through a post processing activity. The second computing apparatus may be remote to the first device and the second device and preferably located on the ground.

In particular, the first computing apparatus is connected to the data storage and/or to the positioning device and/or to at least a depth gauge to calculate the pixel position in the 2D image of light beam and the second computing apparatus is connected to the data storage to calculate the position of the first device and/or the second device relative to the main reference frame by using the data stored in the data storage.

According to an embodiment of the invention, the position of the second device or the first device used in the method for calculating the position of the first device or the second device, respectively, is stored in a data storage or provided by a position device and/or the depth of the first device and/or the second device in the water is stored in a data storage or measured by a depth gauge.

In other words, the position of the second device or the first device used for calculating the position of the first device or the second device, respectively, is stored in a data storage or provided by a position device and the depth of the first device in the water is stored in the data storage or measured by a depth gauge comprised in the first device and the depth of the second device in the water is stored in the data storage or measured by a depth gauge comprised in the second device.

In particular, the position device comprises at least one of an absolute position sensor, a real-time kinematic (RTK) positioning system, a mobile-phone tracking, a real-time locating system based on radio, optical or ultrasonic technology, and a positioning system based on methods of underwater acoustic positioning, as USBL, LBL or SBL, wherein the first device or the second device is preferably provided with the position device.

According to an embodiment of the invention, the step of obtaining the position and/or depth of the first device comprises the following sub-step:
modulating the emitted light beam so that the light beam transmits information about the position and/or depth of the first device,
detecting the light beam by an optical sensor,
determining the position and/or depth of the first device based on the light beam detected by the optical sensor.

According to an embodiment of the invention, the step of obtaining the position and/or depth of at least one of the first device and the second device in the water comprises the following sub-step:
emitting an acoustic or electric signal which represents the position and/or depth of one between the first device and the second device,
receiving the acoustic or electric signal,
determining the position and/or depth of the one between the first device and the second device based on the received acoustic or electric signal.

According to an embodiment of the invention, the method comprises a step of predicting a next position of the light beam in the 2D image captured through the camera by performing a recursive filtering based on at least an actual position and previous positions of the light beam in the 2D image.

Finally, it should be noted that the system and method for geolocation of an object in water of the claimed invention allows to calculate (in particular estimate) the partial or full orientation in the 3D space of one of the first device and second device respect to the other one if the first device has at least two co-rigid light sources (which means the distance between each couple of light sources is fixed). At least two light sources are needed to calculate the partial orientation in 3D space whereas at least three not aligned light sources are needed to calculate the full orientation in 3D space.

Therefore, according to an embodiment of the invention, the first device comprises at least two light sources apt to emit respective light beams, the distance between each couple of light sources being fixed (i.e. it does not change over time).

The processing unit is configured to:
calculate the pixel position in the 2D image of each light beam emitted by the at least two light sources of the first device,
calculate the position of each of the at least two light sources relative to the main reference frame based on the pixel position of the relevant light beam, the orientation of the camera, a position of the second device relative to the main reference frame and the vertical distance, and
determine the orientation of the first device relative to the second device based on the calculated positions of the at least two light sources.

In particular, for two light sources, the partial orientation in 3D is determined by geometric approaches, which means at first by calculating the vector joining the positions of the two light sources and then estimating its orientation by calculating the necessary 3D rotation (through an Euler angle rotation matrix or quaternion rotation) of an initial reference vector to obtain the estimated vector between the light sources. In particular, for three not aligned light sources, the full orientation in 3D of their supporting surface or object is calculated by at first estimating the partial orientations in 3D of the two different vectors connecting the three positions of the light sources by estimating their rotations with respect to their reference vectors on a reference plane, i.e. the horizontal, having the same angle between them as the two vectors connecting the three light source positions; then the full orientation of the plane identified by the three light source positions is calculated by solving a system of equations having the two light source position vectors equaled to their respective rotations of their two corresponding reference vectors.

For more of three not aligned light sources, the orientation of the surface or solid over which the light sources are fixed may be determined by statistically averaging and renormalizing the estimated orientations of a sample or all combinations of three not aligned light sources chosen among the full list of light sources.

For each combination of three not aligned light sources, the full orientation in 3D is calculated by at first estimating the partial orientations in 3D of the two different vectors connecting the three positions of the light sources by estimating their rotations with respect to their reference vectors on a reference plane, i.e. the horizontal, having the same angle between them as the two vectors connecting the three light source positions; then the full orientation of the plane identified by the three light source positions is calculated by solving a system of equations having the two light source position vectors equaled to their respective rotations of their two corresponding reference vectors. In addition or alternatively, the processing unit is configured to:
calculate the pixel position in the 2D image of each light beam emitted by the at least two light sources of the first device,
calculate the position of each of the at least two light sources relative to the main reference frame based on the pixel position of the relevant light beam, an orientation of a rigid surface of the first device relative to the main reference frame, a position of the first device relative to the main reference frame and the vertical distance, and
determine the orientation of the second device relative to the first device based on the calculated positions of the at least two light sources.

Preferably, the rigid surface is provided with the at least two light sources apt to emit respective light beams and the orientation of the rigid surface of the first device relative to the main reference frame is defined by a set of three angles (i.e. pitch, roll and yaw) or a rotation quaternion vector, wherein the first device comprises inertial and magnetic sensors to measure the rotation of the rigid surface about pitch, roll and yaw axes or a rotation quaternion vector.

The method according to an embodiment of the claimed invention comprises:
calculating the pixel position in the 2D image of each light beam emitted by each light source of the first device, wherein the first device comprises at least two light sources apt to emit respective light beams, the distance between each couple of light sources being fixed (i.e. it does not change over time),
calculating the position of each of the at least two light sources relative to the main reference frame based on the pixel position of the relevant light beam, the orientation of the camera, a position of the second device relative to the main reference frame and the vertical distance, and determining the orientation of the first device relative to the second device based on the calculated positions of the at least two light sources, or
calculating the position of each of the at least two light sources relative to the main reference frame based on the pixel position of the relevant light beam, an orientation of a rigid surface of the first device relative to the main reference frame, a position of the first device relative to the main reference frame and the vertical distance, and determining the orientation of the second device relative to the first device based on the calculated positions of the at least two light sources.

Finally, it should be noted that each of sensors and/or measuring device and/or processing unit and/or computing units may associate a timestamp or time signature to each measurement (as image, depth, altitude, orientation, GPS or RTK position, etc) and save it as well on the storage device or transmit it together with such measures. These timestamps could be used to identify synchronous measurements, through a synchronisation procedure of all the device clocks, or via algorithmic statistical approaches.

### BRIEF DESCRIPTION OF THE DRAWINGS

Features and advantages of the invention will be better appreciated from the following detailed description of preferred embodiments thereof which are illustrated by way of non-limiting example with reference to the appended Figures, in which:

FIG. 1 is a schematic view of a system for geolocation of an object in water according to an embodiment of the invention,

FIG. 2 shows a pinhole camera model related to a camera which is comprised in the system of FIG. 1,

FIG. 3 shows a calculated position relative to a main reference frame of a first device of system shown in FIG. 1,

FIG. 4 shows a trajectory estimation over time of a light beam of system shown in FIG. 1,

FIG. 5 is a schematic view of a system for geolocation of an object in water according to a second embodiment of the invention, and

FIG. 6 is a schematic view of a system for geolocation of an object in water according to a third embodiment of the invention.

### DESCRIPTION OF EMBODIMENTS OF THE INVENTION

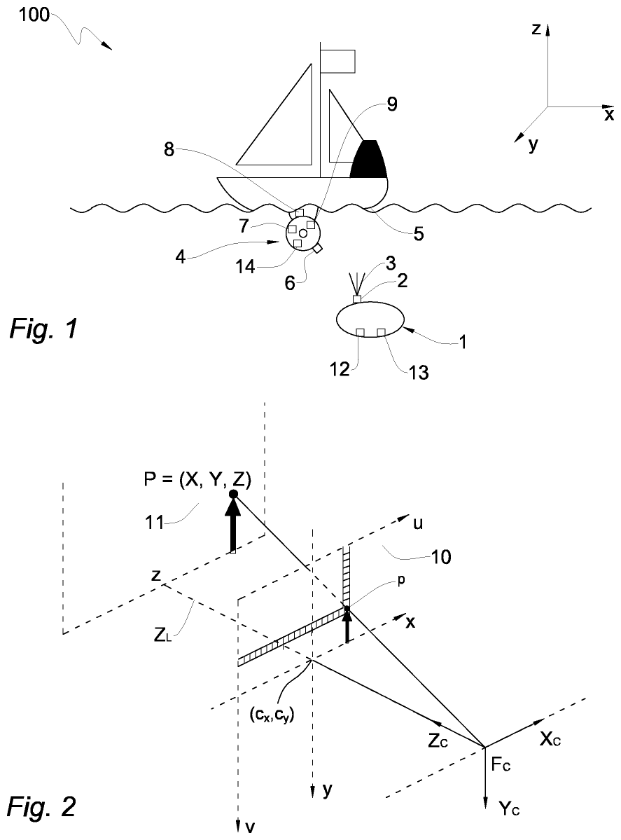

With reference to FIG. 1, a system for geolocation of an object in water according to the present invention is indicated as a whole by the reference number 100. The system comprises a first device, in particular a ROV, 1 immersed in water. The first device 1 has a light source 2 (LED device) apt to emit a light beam 3. The system comprises a second device 4 fixed to a boat hull 5.

The second device 4 comprises a camera 6 for taking 2D images and a measuring device 7 arranged to provide an orientation of the camera 6 relative to a main reference frame defined by three orthogonal axes X, Y, Z.

The measuring device 7 comprises inertial sensors and a magnetic compass for providing the orientation imu_{cam} of the camera 6 relative to the main reference frame.

As shown in FIG. 2, the camera 6 has a camera reference frame defined by three orthogonal axes X_{c}, Y_{c} Z_{c}, wherein Z_{c} extends along the optical axis of the camera 6. The orientation of the camera 6 relative to a main reference frame (X,Y,Z) is defined by a set of three angles: pitch, roll and yaw, wherein the pitch is a motion of the camera about the X_{c} axis, the roll is a motion of the camera about the Y_{c} axis and the yaw is a motion of the camera about the Z_{c} axis.

The second device 4 further comprises a GPS sensor 8 for measuring the position of the second device 4, in particular the position P_{cam} of the camera 6, relative to the main reference frame.

The second device 4 comprises a processing unit 9 operatively connected to the camera 6. The processing unit 9 is configured to determine a vertical distance Δz between the first device 1 and the second device 4 based on the depth in the water of both devices. The distance Zₗ between the first device 1 and the second device 4 is the distance between the image plane 10 of the camera 6 and the light plane 11 of the light beam 3. The vertical distance Δz includes offsets of the camera 6 with the water surface and the light with a depth gauge 12 of the first device 1 apt to measure the depth of the first device 1 in the water.

For instance, the position of the camera 6 (in mm) relative to the main reference frame (X,Y,Z) is P_{cam} (=(X_{cam}, Y_{cam}, 0)=(380,0,0), the orientation of the camera 6 relative to the main reference frame is imu_{cam}=(pitch, roll, yaw)=(π, 0,0) and the vertical distance is Δz=−650 (mm). Δz is given by the difference between the depth of the light source, −650 mm, and the null depth of the camera.

The pitch is set to π since the camera 6 is down looking with respect to the vertical whereas the roll is 0.

Moreover, in this example the camera 6 has an intrinsic camera matrix Cₘ and distortion parameters k₁, k₂, k₃, p₁, p₂ defined as follows:

$${C}_{m} = ( \begin{matrix}{f}_{x} & s & {c}_{x} \\ 0 & {f}_{y} & {c}_{y} \\ 0 & 0 & 1\end{matrix} ) = ( \begin{matrix}387.84 & 0 & 329.86 \\ 0 & 386.03 & 179.79 \\ 0 & 0 & 1\end{matrix} )$$

$$[ \begin{matrix}{k}_{1} \\ {k}_{2} \\ {k}_{3} \\ {p}_{1} \\ {p}_{1}\end{matrix} ] = [ \begin{matrix}- 0.333 \\ 0.126 \\ - 0.0026 \\ - 0.0009 \\ - 0.018\end{matrix} ]$$

The processing unit 9 is configured to capture a 2D image of the light beam 3 through the camera 6 and to calculate the pixel position p=(pᵤ,pᵥ) in the 2D image of light beam 3 through a light beam detection, wherein pᵤ,pᵥ are the position in pixel of light beam 3 along u,v axes which define the image reference frame of the image plane 10.

In this example, the calculated pixel position is:

$$p = [ \begin{matrix}{p}_{u} \\ {p}_{v}\end{matrix} ] = [ \begin{matrix}93 \\ 189\end{matrix} ]$$

The processing unit 9 is also configured to calculate a position P of the first device 1 (light beam 3) relative to the main reference frame based on the pixel position p of the light beam, the orientation of the camera, the position P_{cam} and the vertical distance Δz.

In particular, the calculation of the position P of the first device 1 entails a calculation of an adjusted pixel position p′=(p′u,p′v) by following equation:

$$[ \begin{matrix}{p}_{u}^{′} \\ {p}_{v}^{′} \\ 1\end{matrix} ] = {Cm}^{- 1} \cdot [ \begin{matrix}{p}_{u} \\ {p}_{v} \\ 1\end{matrix} ]$$

and a distortion correction operation applied to the adjusted pixel position p′ to obtain an undistorted pixel position pu=(puᵤ, puᵥ) of the light beam 3.

The undistorted pixel position pu=(puᵤ, puᵥ) of the light beam 3 is obtained by solving the following equations:

puᵤ(1+r²k₁+r⁴k₂+r⁶k₃)+[2p₁puᵤpuᵥ+p₂(r²+2puᵤ²)]−p′ᵤ=0

puᵥ(1+r²k₁+r⁴k₂+r⁶k₃)+[2p₂puᵤpuᵥ+p₁(r²+2puᵤ²)]−p′ᵥ=0

and r=\sqrt{(puᵤ²+puᵥ²)}.

The undistorted pixel position is therefore:

$$p {u}_{u} = [ \begin{matrix}{pu}_{u} \\ p {u}_{v}\end{matrix} ] = [ \begin{matrix}- 0.6688 \\ 0.0260\end{matrix} ]$$

In order to calculate the position of the first device relative to the main reference frame, the unrotated vector p_{uR} can be obtained by following equation:

$${P}_{u R} := [ \begin{matrix}{P}_{u {R}_{X}} \\ {P}_{u {R}_{Y}} \\ {P}_{u {R}_{Z}}\end{matrix} ] = R . [ \begin{matrix}p {u}_{u} \\ p {u}_{v} \\ 1\end{matrix} ]$$

where R is a rotation matrix which represents the orientation of the camera relative to a main reference frame. The rotation matrix R could be given from successive Euler rotations given the Euler angles (pitch, roll and yaw) measured by the inertial sensors, and preferably in their supposed order, or directly estimated from the inertial sensors supplied quaternions. In a particular embodiment, R can be given by the following matrix:

$$R = ( \begin{matrix}C [ ϕ ] C [ ψ ] & - C [ ψ ] S [ ϕ ] & S [ ψ ] \\ C [ θ ] S [ ϕ ] + C [ ϕ ] S [ θ ] S [ ψ ] & C [ θ ] C [ ϕ ] - S [ θ ] S [ ϕ ] S [ ψ ] & - C [ ψ ] S [ θ ] \\ S [ θ ] S [ ϕ ] - C [ θ ] C [ ϕ ] S [ ψ ] & C [ ϕ ] S [ θ ] + C [ θ ] S [ ϕ ] S [ ψ ] & C [ θ ] C [ ψ ]\end{matrix} )$$

where here C[ ] stands for the cos[ ] function, S[ ] for the sin[ ] function, ϕ=yaw, and ψ=roll and θ=pitch, whose rotations have been taken in this order.

Alternatively, R can be given by the following matrix:

$$R = ( \begin{matrix}1 - 2 {( {q}_{4} + {q}_{3} )}^{2} & 2 ( {q}_{2} {q}_{3} - {q}_{1} {q}_{4} ) & 2 ( {q}_{2} {q}_{4} + {q}_{1} {q}_{3} ) \\ 2 ( {q}_{2} {q}_{3} + {q}_{1} {q}_{4} ) & 1 - 2 {( {q}_{2} + {q}_{4} )}^{2} & 2 ( {q}_{3} {q}_{4} - {q}_{1} {q}_{2} ) \\ 2 ( {q}_{2} {q}_{4} - {q}_{1} {q}_{3} ) & 2 ( {q}_{3} {q}_{4} + {q}_{1} {q}_{2} ) & 1 - 2 {( {q}_{2} + {q}_{3} )}^{2}\end{matrix} )$$

where the q₁, q₂, q₃, q₄ are given by the joint operation of the camera magnetic compass (and/or GPS compass) and inertial measurement unit.

In the example, given imu_{cam}=(pitch,roll,yaw)=(π, 0,0), where pitch=π since the camera is down looking, R becomes the:

$$R = ( \begin{matrix}Cos [ ϕ ] & - Sin [ ϕ ] & 0 \\ - Sin [ ϕ ] & - Cos [ ϕ ] & 0 \\ 0 & 0 & - 1\end{matrix} ) = ( \begin{matrix}1 & 0 & 0 \\ 0 & - 1 & 0 \\ 0 & 0 & - 1\end{matrix} )$$

And p_{uR}=(−0.6688, −0.0260, −1).

In this example p_{uR} is renormalized, preferably in mm, to obtain P_{R}=(P_{R}_{ₓ}, P_{R}_{_{y}}, P_{R}_{_{z}}) according to the equation:

P_{R}−p_{uR}α

In this example, α=Z_{L}, where Z_{L} is the (minimum) distance between the camera plane and the light plane. Preferably, the light plane is the plane parallel to the camera plane and passing through the point in space defined by the light source.

Z_{L} is given by the

Z_{L}=Δz Sec(ψ−ArcTan(puᵤ))Sec(θ−ArcTan(−puᵥ))/(\sqrt{1+puᵤ²}\sqrt{1+puᵥ²})

With Sec the secant function, ψ=roll and θ=pitch. Δz is given by the difference between the depth of the light source and the depth of the camera.

In this example, α=Z_{L}=−Δz=650 and P_{R}=(−434.747, −16.9138, −650), expressed in mm since Z_{L} in mm.

The position P=(P_{X},P_{Y},P_{Z}) of the first device relative to the main reference frame (X,Y,Z) can therefore be obtained by the translation equation:

P=P_{R}+t

where t=(t_{X},t_{Y},t_{Z}) is a translation vector which represents the position of the second device relative to the main reference frame (X,Y,Z) that is t=P_{cam}=(X_{cam}, Y_{cam}, 0).

Since P_{cam}=(380,0,0), therefore P=(P_{X},P_{Y},P_{z})=(−54.74, −16.913, −650).

The first device comprises a first control unit 13 connected to the light source 2 for modulation of light beam 3 so that the light beam transmits information about the depth of the first device 1.

The second device comprises an optical sensor 14 (a photodiode) apt to detect the light beam 3, the processing unit 9 being connected to the optical sensor 14 for obtaining the depth of the first device 1 based on the light beam detected by the optical sensor 14.

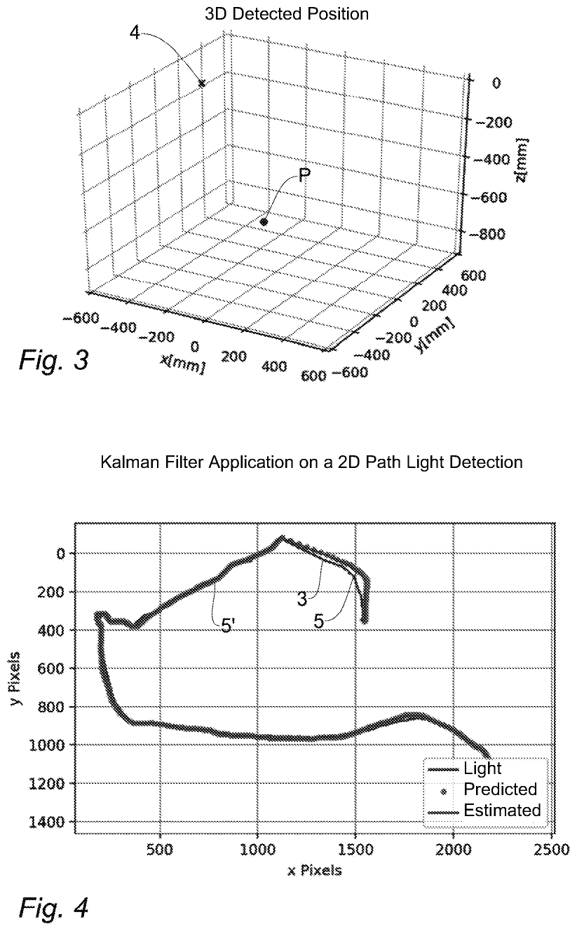

FIG. 3 shows the calculated position of the first device 1 relative to the main reference frame (X,Y,Z).

FIG. 4 shows a trajectory estimation of the light beam over time by an embodiment of Kalman filter according to the invention, wherein the camera 6 is moved along X and Y axes, the first device 1 is fixed and the yaw is aligned with camera vision. The camera 6 has a camera FPS (frame per second) equal to 25, so T is:

$$T = [ \begin{matrix}1 & 0 & 0.04 & 0 \\ 0 & 1 & 0 & 0.04 \\ 0 & 0 & 1 & 0 \\ 0 & 0 & 0 & 1\end{matrix} ]$$

In addition, P₀, Q and H are set as:

$${P}_{0} = [ \begin{matrix}1 & 0 & 0 & 0 \\ 0 & 1 & 0 & 0 \\ 0 & 0 & 1 & 0 \\ 0 & 0 & 0 & 1\end{matrix} ]$$

$$Q = [ \begin{matrix}6.4 {10}^{- 7} & 0 & 3.2 {10}^{- 5} & 0 \\ 0 & 6.4 {10}^{- 7} & 0 & 3.2 {10}^{- 5} \\ 3.2 {10}^{- 5} & 0 & 1.6 {10}^{- 3} & 0 \\ 0 & 3.2 {10}^{- 5} & 0 & 1.6 {10}^{- 3}\end{matrix} ]$$

$$H = [ \begin{matrix}1 & 0 & 0 & 0 \\ 0 & 1 & 0 & 0\end{matrix} ]$$

And J is a null 4×4 matrix.

Below, a table showing twenty example points, ten at the beginning of the series and ten at the end, of the observed undistorted light position oₖ=(puᵤ, pvᵤ), the predicted state s′ₖ and the estimated state sₖ which have been obtained by the Kalman filter according to the above-mentioned parameters.

| k | 0 | 1 | 2 | 3 | 4 |
|---|---|---|---|---|---|
| oₖ | 601, 348 | 600, 347 | 600, 347 | 599, 346 | 599, 346 |
| s′ₖ | 0.0, | 595.96, | 599.28, | 601.36, | 601.04, |
| | 0.0, 0.0, 0.0 | 345.56, 24.0, 14.0 | 346.68, 32.0, 17.0 | 347.72, 34.0, 18.0 | 347.48, 26.0, 12.0 |
| sₖ | 595.0, | 598.0, | 600.0, | 600.0, | 600.0, |
| | 345.0, 24.0, 14.0 | 346.0, 32.0, 17.0 | 347.0, 34.0, 18.0 | 347.0, 26.0, 12.0 | 347.0, 20.0, 7.0 |
| k | 5 | 6 | 7 | 8 | 9 |
| oₖ | 598, 345 | 597, 345 | 597, 344 | 596, 343 | 596, 343 |
| s′ₖ | 600.8, | 600.52, | 599.2, | 598.04, | 596.92, |
| | 347.28, 20.0, 7.0 | 346.04, 13.0, 1.0 | 345.96, 5.0, −1.0 | 344.8, 1.0, −5.0 | 343.68, −2.0, −8.0 |
| sₖ | 600.0, | 599.0, | 598.0, | 597.0, | 597.0, |
| | 347.0, 20.0, 7.0 | 346.0, 5.0, −1.0 | 345.0, 1.0, −5.0 | 344.0, −2.0, −8.0 | 343.0, −3.0, −9.0 |
| k | 730 | 731 | 732 | 733 | 734 |
| oₖ | 242, 182 | 241, 182 | 240, 183 | 239, 183 | 238, 184 |
| s′ₖ | 242.56, | 241.56, | 240.56, | 239.56, | 238.56, |
| | 181.44, −11.0, 11.0 | 182.44, −11.0, 11.0 | 182.44, −11.0, 11.0 | 183.44, −11.0, 11.0 | 183.44, −11.0, 11.0 |
| sₖ | 242.0, | 241.56, | 240.0, | 239.0, | 238.0, |
| | 182.0, −11.0, 11.0 | 182.44, −11.0, 11.0 | 183.0, −11.0, 11.0 | 183.0, −11.0, 11.0 | 184.0, −11.0, 11.0 |
| k | 735 | 736 | 737 | 738 | 9 |
| oₖ | 237, 184 | 237, 184 | 235, 185 | 234, 185 | 234, 186 |
| s′ₖ | 237.56, | 236.56, | 235.56, | 234.56, | 234.56, |
| | 184.44, −11.0, 11.0 | 184.44, −11.0, 11.0 | 185.44, −11.0, 11.0 | 185.44, −11.0, 11.0 | 185.44, −11.0, 11.0 |
| sₖ | 237.0, | 236.0, | 235.0, | 234.0, | 234.0, |
| | 184.0, −11.0, 11.0 | 185.0, −11.0, 11.0 | 185.0, −11.0, 11.0 | 185.0, −11.0, 11.0 | 186.0, −11.0, 11.0 |

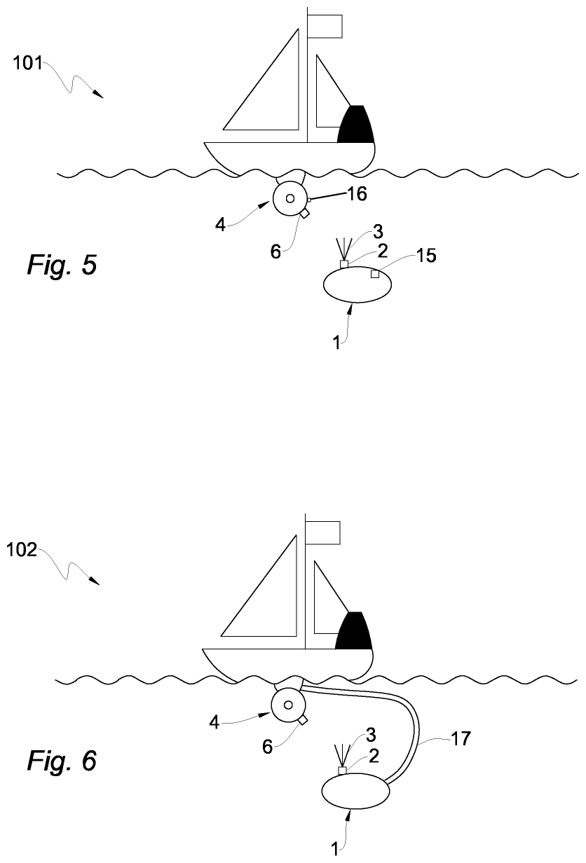

FIG. 5 is a schematic view of a system for geolocation of an object in water according to a second embodiment of the invention. This system is indicated as a whole by the reference number 101.

System 101 differs from system 100 described above by the first device 1 has an acoustic emitter 15 for emitting an acoustic signal which represents the depth of the first device 1. The second device 4 has an acoustic receiver 16 for receiving the acoustic signal emitted by the acoustic emitter 15.

The processing unit 9 is connected to the acoustic receiver 16 for obtaining the depth of the on first device based on the signal received by the acoustic receiver 16.

FIG. 6 is a schematic view of a system for geolocation of an object in water according to a third embodiment of the invention. This system is indicated as a whole by the reference number 102.

System 102 differs from system 100 described above by the first device 1 and the second device 4 are connected to each other by a marine communication cable 17 through which the first device 1 transmits to the second device 4 information on its depth. The invention thereby solves the problem set out, at the same time achieving a number of advantages. In particular, the system for geolocation of an object in water according to the invention has a reduced architectural complexity compared to the known systems.

1. System (100;101;102) for geolocation of an object in water, the system comprising:
a first device (1) configured to be immersed in, or to float on, water, the first device (1) comprising a light source (2) apt to emit a light beam (3),
a second device (4) configured to be immersed in, or to float on, water, the second device (4) comprising a camera (6) for taking 2D images and a measuring device (7) arranged to provide an orientation of the camera (6) relative to a main reference frame defined by three orthogonal axes (X, Y, Z),
a processing unit (9) operatively connected to at least the camera (6), the processing unit (9) being configured to:
determine a vertical distance (Δz) between the first device (1) and the second device (4) based on a depth in the water of both devices,
capture a 2D image of the first device (1) through the camera (6),
calculate the pixel position in the 2D image of light beam (3) emitted by the light source (2) of the first device (1), and
calculate a position of the first device (1) relative to the main reference frame based on the pixel position of the light beam (3), the orientation of the camera (6), a position of the second device (4) relative to the main reference frame and the vertical distance (Δz) and/or to calculate a position of the second device (4) relative to the main reference frame based on the pixel position of the light beam (3), the orientation of the camera (6), a position of the first device (1) relative to the main reference frame and the vertical distance (Δz).

2. The system according to claim 1, wherein the position of the second device (4) or the first device (1) used for calculating the position of the first device (1) or the second device (4), respectively, is stored in a data storage or provided by a position device and wherein the depth of the first device (1) in the water is stored in the data storage or measured by a depth gauge (12) comprised in the first device (1) and the depth of the second device (4) in the water is stored in the data storage or measured by a depth gauge comprised in the second device (4).

3. The system according to claim 2, wherein the processing unit (9) is operatively connected to the data storage and/or the position device so as to obtain the position of the second device (4) or the first device (1) for calculating the position of the first device (1) or the second device (4), respectively, and wherein the processing unit (9) is operatively connected to the data storage and/or the depth gauge of the first device (1) so as to obtain the depth of the first device (1) in the water and to the data storage and/or the depth gauge of the second device (4) so as to obtain the depth of the second device (4) in the water for determining the vertical distance (Δz).

4. The system according to claim 3, wherein the position device comprises at least one of an absolute position sensor, a real-time kinematic (RTK) positioning system, a mobile-phone tracking, a real-time locating system based on radio, optical or ultrasonic technology, and a positioning system based on methods of underwater acoustic positioning, as USBL, LBL or SBL, wherein the first device (1) or the second device (4) is provided with the position device.

5. The system according to claim 1, wherein the first device (1) comprises a first control unit (13) connected to the light source (2) for modulation of the light beam (3) so that the light beam (3) transmits information about the position and/or depth of the first device (1) and wherein the second device (4) comprises an optical sensor (14) configured to detect the light beam (3), the processing unit (9) being connected to the optical sensor (14) for obtaining the position and/or depth of the first device (1) based on the light beam (3) detected by the optical sensor (14).

6. The system according to claim 1, wherein one of the first device (1) or the second device (4) has an acoustic emitter (15) for emitting an acoustic signal which represents the position and/or depth of the relevant device and the other of the first device and the second device has an acoustic receiver (16) for receiving the acoustic signal emitted by the acoustic emitter (15), the processing unit (9) being connected to the acoustic receiver (16) for obtaining the position and/or depth of the one of the first device (1) or the second device (4) based on the signal received by the acoustic receiver (16).

7. The system according to claim 1, wherein the first device (1) and the second device (4) are connected to each other by a marine communication cable (17) through which the first device transmits to the second device information on its depth and/or position and/or the second device transmits to the first device information on its depth and/or position.

8. The system according to claim 1, wherein the processing unit is configured to predict a next position of the light beam (3) in the 2D image captured y the camera (6) by performing a recursive filtering algorithm based on at least an actual position and previous positions of the light beam (3) in the 2D image.

9. The system according to claim 1, wherein the first device comprises at least two light sources configured to emit respective light beams, the distance between each couple of light sources being fixed, and wherein the processing unit (9) is configured to:
calculate the pixel position in the 2D image of each light beam emitted by the at least two light sources of the first device, and
calculate the position of each of the at least two light sources relative to the main reference frame based on the pixel position of the relevant light beam, the orientation of the camera, a position of the second device relative to the main reference frame and the vertical distance, and to determine the orientation of the first device relative to the second device based on the calculated positions of the at least two light sources, and/or
calculate the position of each of the at least two light sources relative to the main reference frame based on the pixel position of the relevant light beam, an orientation of a rigid surface of the first device relative to the main reference frame, a position of the first device relative to the main reference frame and the vertical distance, and to determine the orientation of the second device relative to the first device based on the calculated positions of the at least two light sources.

10. Method for geolocation of an object in water, the method comprising:
putting a first device (1) into water, wherein the first device comprising a light source (2) configured to emit a light beam (3),
putting a second device (4) into the water, the second device comprising a camera (6) for taking images,
emitting the light beam (3) by means of the light source (2),
obtaining an orientation of the camera (6) relative to a main reference frame defined by three orthogonal axes (X, Y, Z),
obtaining a depth of the first device (1) and the second device (4) in the water,
determining a vertical distance (Δz) between the first device (1) and the second device (4) based on the depth thereof in the water,
capturing a 2D image of the first device (1) via the camera (6),
calculating the pixel position in the 2D image of the light beam (3) emitted by the light source (2) of the first device (1), and
obtaining a position of the second device (4) relative to the main reference frame and calculating a position of the first device (1) relative to the main reference frame based on the pixel position of the light beam (3), the orientation of the camera (6), the position of the second device (4) relative to the main reference frame and the vertical distance (Δz), or obtaining a position of the first device (1) relative to the main reference frame and calculating a position of the second device (4) relative to the main reference frame based on the pixel position of the light beam (3), the orientation of the camera (6), the position of the first device (1) relative to the main reference frame and the vertical distance (Δz).

11. The method according to claim 10, wherein the position of the second device (4) or the first device (1) used for calculating the position of the first device (1) or the second device (4), respectively, is stored in a data storage or provided by a position device and wherein the depth of the first device in the water is stored in the data storage or measured by a depth gauge (12) comprised in the first device (1) and the depth of the second device (4) in the water is stored in the data storage or measured by a depth gauge comprised in the second device (4).

12. The method according to claim 11, wherein the position device comprises at least one of an absolute position sensor, a real-time kinematic (RTK) positioning system, a mobile-phone tracking, a real-time locating system based on radio, optical or ultrasonic technology, and a positioning system based on methods of underwater acoustic positioning, as USBL, LBL or SBL, wherein the first device (1) or the second device (4) is provided with the position device.

13. The method according to claim 10, wherein the step of obtaining the position and/or depth of the first device (1) comprises:
modulating the emitted light beam (3) so that the light beam transmits information about the position and/or depth of the first device (1),
detecting the light beam (3) by an optical sensor (14), and
determining the position and/or depth of the first device (1) based on the light beam (3) detected by the optical sensor (14).

14. The method according to any one of claims 10-13, wherein the step of obtaining the position and/or depth of at least one of the first device (1) and the second device (4) in the water comprises:
emitting an acoustic or electric signal which represents the position and/or depth of one between the first device (1) or the second device (4),
receiving the acoustic or electric signal,
determining the position and/or depth of the one between the first device (1) or the second device (4) based on the received acoustic or electric signal.

15. The method according to claim 10, further comprising:
predicting a next position of the light beam (3) in the 2D image captured through by the camera (6) by performing a recursive filtering based on at least an actual position and previous positions of the light beam (3) in the 2D image.

16. The method according to claim 10, wherein the first device comprises at least two light sources configured to emit respective light beams, the distance between each couple of light sources being fixed, the method further comprising:
calculating the pixel position in the 2D image of each light beam emitted by each light source of the first device,
calculating the position of each of the at least two light sources relative to the main reference frame based on the pixel position of the relevant light beam, the orientation of the camera, a position of the second device relative to the main reference frame and the vertical distance, and determining the orientation of the first device relative to the second device based on the calculated positions of the at least two light sources, or
calculating the position of each of the at least two light sources relative to the main reference frame based on the pixel position of the relevant light beam, an orientation of a rigid surface of the first device relative to the main reference frame, a position of the first device relative to the main reference frame and the vertical distance, and determining the orientation of the second device relative to the first device based on the calculated positions of the at least two light sources.
